(19) United States
(12) Patent Application Publication
(10) Pub. No.: US 2008/0236430 A1
(43) Pub. Date: Oct. 2, 2008

(54) Method for Determining Optimized Ink Presetting Characteristic Curves for Controlling Inking Units in Printing Presses and Printing Press for Carrying out the Method

(75) Inventors: Peter Elter, Muhlhausen (DE); Nikolaus Pfeiffer, Heidelberg (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/060,934

(22) Filed: Apr. 2, 2008

(30) Foreign Application Priority Data
Apr. 2, 2007 (DE) 10 2007 016 156.7

(51) Int. Cl. B41F 33/00

(52) U.S. Cl. 101/484

(57) ABSTRACT

A method for determining optimized ink presetting characteristic curves for the control of inking units in printing presses through the use of a computer, includes acquiring measured values on a printing material produced by a printing press within the context of a running print job, through the use of a color measuring instrument. The acquired measured values are compared with a color set point to be achieved, fluctuations in the acquired measured values are determined and, if fluctuations lie within a defined permissible tolerance band around the color set point, the computer generates a signal to adapt and store the ink presetting characteristic curves used for the running print job. A printing press for carrying out the method is also provided.

### CROSS-REFERENCE TO RELATED APPLICATION

This application claims the priority, under 35 U.S.C. § 119, of German Patent Application DE 10 2007 016 156.7, filed Apr. 2, 2007; the prior application is herewith incorporated by reference in its entirety.

### BACKGROUND OF THE INVENTION

### Field of the Invention

The present invention relates to a method for determining optimized ink presetting characteristic curves for the control of inking units in printing presses through the use of a computer, in which measured values on a printing material produced by a printing press within the context of a running print job are acquired through the use of a color measuring instrument. The present invention also relates to a printing press for carrying out the method.

German Published, Non-Prosecuted Patent Application DE 10 2004 033 056 A1, corresponding to U.S. Patent Application Publication No. US 2005/0028700 A1, discloses automated operation through the use of operating agents in printing presses. In that technology, a computer uses the operating states of the printing press and the print jobs running on the printing press to determine the settings of the printing press needed for the processing of the respective print job and notifies the operating personnel about manual interventions at the correct time. In that case, the optimization of characteristic curves by using logged data from the print jobs being carried out is also proposed. In that case, the control device of the printing press registers frequent changes in the characteristic curves, in particular of an inking unit in the printing press, and notes those changes in order to select the characteristic curves preferred by an operator in the event of repeated operation of the printing press by the same operator. In addition, the control device can offer the operating personnel the transfer of characteristic curves from similar print jobs which other operating personnel have used on the same printing press, so that anyone who operates the printing press is able to profit from the experience of other users. However, German Published, Non-Prosecuted Patent Application DE 10 2004 033 056 A1, corresponding to U.S. Patent Application Publication No. US 2005/0028700 A1, makes no statement as to how to determine the correct time at which the optimization of the characteristic curves is to be proposed to the operating personnel. The criteria needed for that purpose do not emerge from that patent application.

### BRIEF SUMMARY OF THE INVENTION

It is accordingly an object of the invention to provide a method for determining optimized ink presetting characteristic curves for controlling inking units in printing presses and a printing press for carrying out the method, which overcome the hereinafore-mentioned disadvantages of the heretofore-known methods and devices of this general type and which determine an expedient time to learn improved ink presetting characteristic curves by using meaningful criteria.

With the foregoing and other objects in view there is provided, in accordance with the invention, a method for determining optimized ink presetting characteristic curves for the control of inking units in printing presses by a computer. The method comprises acquiring measured values on a printing material produced by a printing press within the context of a running print job by a color measuring instrument, comparing the acquired measured values with a color set point to be achieved, determining fluctuations or variations in the acquired measured values and, if the fluctuations lie within a defined permissible tolerance band around the color set point, generating a signal in the computer to adapt and store the ink presetting characteristic curves being used.

With the objects of the invention in view, there is also provided a printing press for carrying out the method according to the invention. The printing press comprises a display device, and a computer for passing a signal to adapt and store ink presetting characteristic curves used for a print job on to the display device causing the display device to generate an optical signal.

In the case of the printing presses known at present, the printer has to improve the ink presetting characteristic curves more or less from his or her own knowledge and ability. This means that the printer must himself or herself decide the time at which the learning of characteristic curves for the ink presetting characteristic curves is best possible. For that purpose, the printer needs considerable knowledge about the relationships which have an effect on the ink presetting characteristic curves in the control of the inking units. Ink presetting characteristic curves are needed for the ink control in inking units of printing presses when a new print job is starting up.

According to the present invention, the printer is sent a signal by the printing press when the printing press is in a state which permits an improved ink presetting characteristic curve to be learned. To this end, use is made of a printing press which has a control computer that is able to control and regulate actuating processes on the inking units in the individual printing units of the machine through actuating motors. The control computer is additionally capable of communicating with a color measuring instrument, which measures the color of the printing materials produced in a currently running print job, so that statements about the color of the printing materials being produced are possible. These color measured values are transmitted from the color measuring instrument to the control computer of the printing press and analyzed there, in particular compared with values from a printing original. In this case, the color measuring instrument being used can be external color measuring instruments which measure printing materials outside the printing press and transmit the data to the control computer. For this purpose, at specific intervals, proof sheets are removed from the printing materials produced in a running print job and are measured with the color measuring instrument.

According to the invention, the measured values acquired by the color measuring instrument are then compared with a color set point to be achieved, which is known to the control computer of the printing press, for example as a result of pre-definitions by the printer or from the printing original. The fluctuations as compared with the color set points, determined during the measurement, are needed in order to decide whether or not the fluctuations that have occurred lie within a permissible tolerance band around the color set point. This tolerance band can, for example, cover a span of +/−5 percent around the color set point and be a specific number of sheets or a specific time interval long. The tolerance band depends on the continuous printing tolerance of the current print job. If all of the acquired measured values lie within the defined permissible tolerance band, the control computer generates an electric signal so that the ink presetting characteristic curve previously used for the current print job is adapted to the color measured values and can be stored as an ink presetting characteristic curve to be learned.

In accordance with another mode of the invention, provision is made for the computer to be connected to a display device, for the computer to pass on the signal to store the ink presetting characteristic curve used for the print job to the display device, and to generate a visual signal there. This visual signal can, for example, be the illumination of a small green lamp on the display device or another appropriate visual signal on the display device configured as a monitor. As soon as this visual signal lights up, the operating personnel know that the correct time has arrived to record and store an improved ink presetting characteristic curve. For the purpose of recording, it is sufficient for the operating personnel to trigger an entry acknowledgement signal through a keyboard, a touch screen or a computer mouse, so that the ink presetting characteristic curve used for the print job can be stored in the computer as an improved ink presetting characteristic curve and used for future print jobs.

In accordance with a further mode of the invention, provision is made for the signal generated by the computer to store the ink presetting characteristic curve used for a print job to trigger automatic recording of the current ink presetting characteristic curve and subsequent storage as an improved characteristic curve in the computer. In this case, the operating personnel of the printing press no longer have to carry out any action at all, since the control computer of the printing press performs the automatic storage of an improved ink presetting characteristic curve automatically. This improved characteristic curve is then used during future print jobs. For this purpose, provision is made for the operating personnel to be able to choose between an automatic recording and a recording with manual actuation, as mentioned previously, for example through the operating menu of a graphic user interface on the monitor. Therefore, the operating personnel can automatically decide whether an automatic recording and storage of an improved ink presetting characteristic curve is desired or whether initially only the information is desired about the correct time when an improved ink presetting characteristic curve can expediently be recorded as a result of visual signaling.

In accordance with an added mode of the invention, provision is made for the computer to analyze the data from the current print job and to generate a signal to store the ink presetting characteristic curve used for the print job, if the print job has no job data which opposes the learning. By using this additional criterion, the intention is that, for example, print jobs which fall out of the frame due to an extreme color or other job properties should not be used to learn ink presetting characteristic curves, since these specific conditions would have a detrimental effect in most of the print jobs otherwise used. This therefore reliably avoids print jobs which fall out of the frame appearing to improve the ink presetting characteristic curve being used, but this leading to considerable worsening for the predominant majority of average print jobs.

In accordance with an additional mode of the invention, provision is advantageously made for the computer to generate a signal to store the ink presetting characteristic curve used for a print job when the ink presetting characteristic curve from the current print job represents an improvement as compared with comparable ink presetting characteristic curves and comparable print jobs from the past. According to this additional criterion, firstly the data from the current print job is compared with data from comparable print jobs from the past and, secondly, the ink presetting characteristic curve currently being used is compared with the earlier ink presetting characteristic curves from comparable print jobs. This avoids the situation where an ink presetting characteristic curve is stored and learned as an improved ink presetting characteristic curve since, although the two criteria mentioned previously are satisfied, the characteristic curve as such is in truth no better than ink presetting characteristic curves in comparable print jobs from the past.

In accordance with yet another mode of the invention, provision is made for the computer to generate a signal to store the ink presetting characteristic curve used for the print job if the operating state of the printing press is not being subjected to any setting operations or actions by operating personnel in the inking units. This criterion avoids the operating personnel, as a result of their own control interventions, putting the printing press into an unstable state in relation to the inking control which accidentally satisfies the aforementioned criteria but, because of its instability, is not reproducible in future print jobs. Accordingly, an improved ink presetting characteristic curve then stored would also not be reproducible in future print jobs, since the settings made by hand are not reproducible. Such an ink presetting curve would thus not be usable. However, the computer reacts to adjustment operations which, for example, are carried out by machine controllers such as the inking controller. Should the inking controller not be in a stable control state or its control interventions exceed a permissible magnitude, it is also necessary to assume an unstable operating state of the printing press in that case, which would consequently not lead to an improved ink presetting characteristic curve in future print jobs. Consequently, in this case no signal to learn the characteristic curve is output either.

In accordance with yet a further mode of the invention, in addition, provision is advantageously made for the computer to generate a signal to store the ink presetting characteristic curve used for the print job if the color set points are unchanged and/or the inking zones of the inking units are blocked against adjustment. The blocking of the inking zones prevents the operating personnel from being able to intervene in the inking control and thus from bringing about an unstable state of the inking control in the printing units. The testing for unchanged color set points is likewise important, since a change in the color set point necessarily leads to readjustment of the inking units in a manner coordinated with the new color set point and likewise constitutes an unstable operating state of the printing press. These unstable operating states are not suitable for the storage of improved ink presetting characteristic curves and can be ruled out by the computer by using this criterion.

In accordance with yet an added mode of the invention, furthermore, provision is made for the measured values on the printing material to be acquired by a color measuring instrument in the printing press, which is connected to the computer through a communications link. Besides the color measurement already mentioned through the use of external color measuring instruments, a determination of measured values by what are known as inline color measuring instruments, which are located in the interior of the printing press and permanently measure the color of sheet printing materials or the printing web, is also possible. In this way, permanent monitoring of the color of the printing materials becomes possible so that, accordingly, a large amount of data is available to compare the position of the actual color with the intended color to be achieved. Thus, the color measured values determined frequently can be compared continually with the desired color measured values. In this way, short-term outliers among the color measured values can also be detected, so that compliance with the predefined tolerance band can be monitored particularly reliably and the fluctuations of the color can be determined reliably by the computer.

In accordance with a concomitant mode of the invention, provision is made for the computer to generate a signal to store the ink presetting characteristic curves used for the print job if, after reaching the stable operating state and the color set point to be achieved, a minimum number of produced printing materials has been produced. In the case of a web-fed rotary printing press, this would correspond to a minimum time interval which is taken into account by the computer before it generates a signal to learn the ink presetting curves. During this time interval, the computer once more checks whether or not process changes are taking place on the printing press. These process changes can, for example, be adjustments of the inking zones, changes in the inking ductor/ink distributor cycle rate in the inking units of the printing press, changes in the dampening unit of the printing press, changes in the color set points on the measuring instrument or changes in the printing speed. The aforementioned changes are not to be understood as final but only exemplary. However, if no process changes have taken place within the envisaged time interval or the envisaged number of printed sheets, it can be assumed that the operating state of the printing press is ultimately to be viewed as stable. This is consequently a further stability criterion with which the quality of the printing process can be assessed by the computer. The more these aforementioned quality criteria are taken into account by the computer, the more reliable is the statement that the printing process is stable and the greater is the probability that, after the generated signal to learn a new ink presetting characteristic curve, the ink presetting characteristic curve which is finally stored is actually better than the ink presetting characteristic curves used in the past.

Other features which are considered as characteristic for the invention are set forth in the appended claims.

Although the invention is illustrated and described herein as embodied in a method for determining optimized ink presetting characteristic curves for controlling inking units in printing presses and a printing press for carrying out the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a sheetfed rotary printing press having a computer programmed in accordance with the invention and a display device; and

FIG. 2 is a diagram showing a typical course of an ink presetting characteristic curve which satisfies a stability criteria.

### DETAILED DESCRIPTION OF THE INVENTION

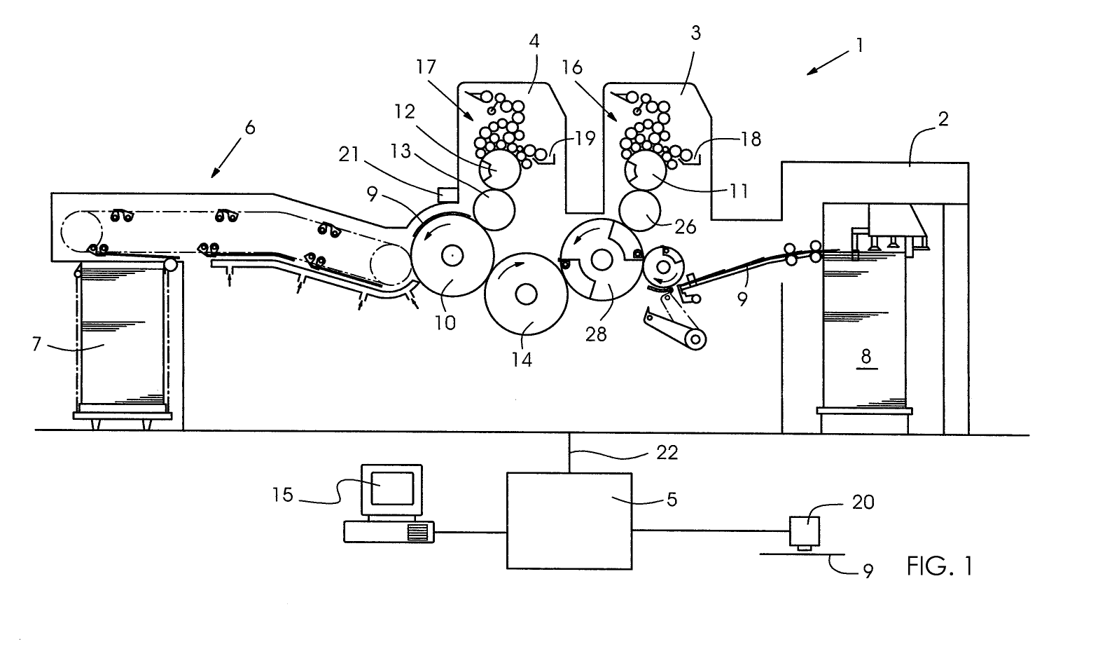

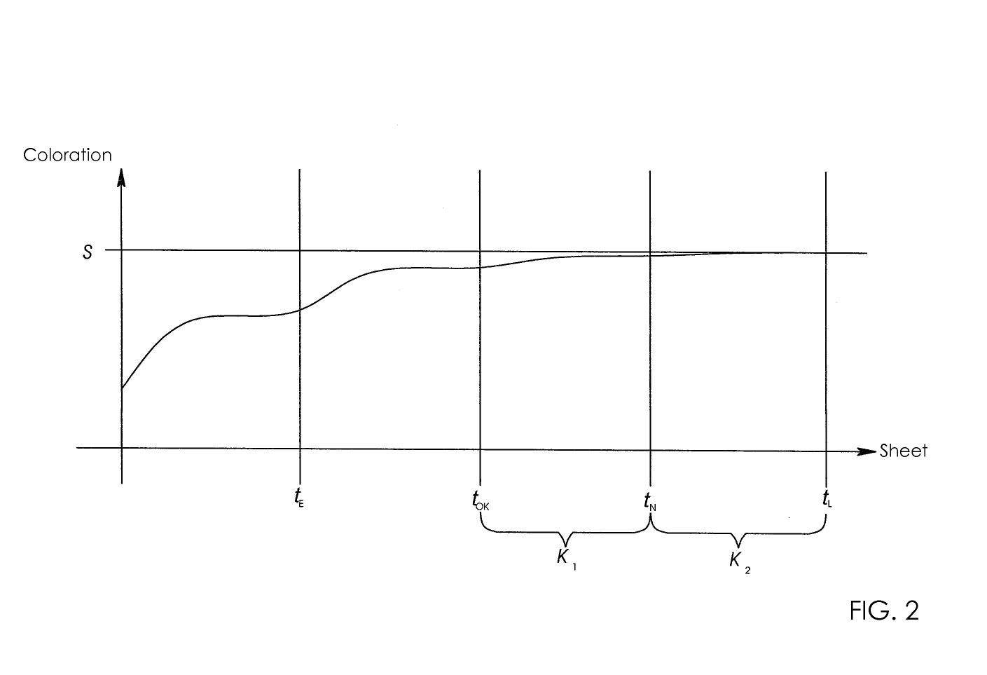

Referring now to the figures of the drawings in detail and first, particularly, to FIG. 1 thereof, there is seen a printing press 1 which has two printing units 3, 4, each of which has an inking unit 16, 17 and a dampening unit 18, 19. The inking units 16, 17 are used for ink metering and have electric actuating motors, which are linked to a control computer 5 of the printing press 1. The ink metered in the inking unit 16, 17 is moistened by using the dampening unit 18, 19. Dampening solution metering in the dampening units 18, 19 can also be monitored by the control computer 5. In the printing units 3, 4, the metered and moistened ink is first transferred to plate cylinders 11, 12 having a printing plate and, from there, to blanket cylinders 13, 26. From there, a printing image is then transferred to printing sheets 9 in the printing press 1 in a printing press nip between the blanket cylinders 13, 26 and impression cylinders 10, 28. The printing materials 9 are transferred between the two printing units 3, 4 through the use of a transport cylinder 14. The required new printing sheets 9 are lifted off a feeder stack 8 through the use of a suction apparatus in a feeder 2 and are fed to the first printing unit 3 over a suction belt table. Following the second printing unit 4, the finished printing materials 9 are transferred to gripper chains in a delivery 6 and deposited on a delivery stack 7. The control computer 5 of the printing press 1 is connected through communications links 22 to all of the electric adjusting motors of the printing press 1 in order to be able to perform desired adjustment operations. In particular, the control computer 5 is able to adjust individual inking zones in the inking units 16, 17 for metering the ink. Also connected to the control computer 5 is a monitor 15, on which the operating state of the printing press 1 is illustrated and through which entries by operating personnel are possible. Furthermore, connected to the control computer 5 through a communications link 22 is an external color measuring instrument 20, with which the color of finally produced printed sheets 9 deposited in the delivery stack 7 can be measured. For this purpose, the printed sheets 9 must be removed from the delivery stack 7 by operating personnel and placed under the color measuring instrument 20. The printing press 1 also has an inline color measuring apparatus 21 at the exit from the second printing unit 4, which can likewise measure the color of the printed sheets 9. The color of the printed sheets 9 being produced can be measured continually by using the inline color measuring apparatus 21, so that color measuring values can be transmitted continually from the inline color measuring instrument 21 to the control computer 5. Color measured values acquired in this way are compared in the control computer 5 with an intended color S (see FIG. 2) which is predefined by the operating personnel and which depends on the respective print job and the associated printing original. The intended color S is used as a target value for the corresponding ink presetting characteristic curve in the inking units 16, 17 of the printing press 1.

Such an improved ink presetting characteristic curve, which has to satisfy a number of criteria, is illustrated in FIG. 2. In this case, it can be seen that these criteria have to be satisfied at specific time intervals t_{E}, t_{OK}, t_{N} and t_{L}. In the first time interval t_{E}, the readjustment of the inking zones in the inking units 16, 17 of the printing press 1 must be completed. It is only when the control computer 5 registers the fact that there are no readjustment operations, that the inking control is set to the desired color S. At this point, a first criterion K1 is then applied. If, between the time t_{OK} and the time t_{N}, which is to say the readjustment of the inking units 16, 17 during the printing of the print run, the color measured values lie within a predefined tolerance band around the color set point S, this first criterion K1 has been satisfied. In this case, a tolerance band expediently has a value of +/−5 percent around the color set point S. When the computer 5 has registered the criterion K1 as satisfied, a second criterion K2 comes into play, which is active from the time t_{N} as far as a learning time t_{L}. This time interval covers a specific number of sheets, and it is necessary for no process changes to be carried out during the production of this number of sheets. The process changes include inking zone changes of more than 5% in the inking units 16, 17, cycle rate and rotational speed changes on the ink ductor and on ink distributors in the inking units 16, 17, printing speed changes, etc. Under certain circumstances, some changes can also be compensated, for example changes in the color set point S can be incorporated into a new ink presetting characteristic curve through the use of the computer 5. If a correction of this type is carried out, then it is possible to dispense with the criterion of the unchanged color set points S or it is possible for the permissible tolerance threshold to be increased to 10%, for example, and the learning of the ink presetting characteristic curve being used can nevertheless be triggered. During the acquisition of the inking zone changes, averaging over a plurality of inking zones can be carried out. The number of printing materials to be produced during the criterion K2 can include 50 sheets and can also include 1,000 sheets. In the event that an inline measuring instrument 21 is used, a number of 100 sheets has also proven to be adequate, during the production of which no process changes may take place in the printing press 1.

If, then, the criterion K2 has likewise been satisfied, the time t_{L} to learn an improved ink presetting characteristic curve has arrived and an appropriate acoustic or visual signal can be displayed, for example on the monitor 15. However, in an improved embodiment, the control computer 5 initially checks whether or not, at least for one inking unit 16, 17, an improved ink presetting characteristic curve has actually been achieved. As a result, the ink presetting characteristic curve currently being used is compared with old characteristic curves and analyzed. It is only if this actually results in an improvement as compared with the old ink presetting characteristic curve that the visual signal is then displayed on the monitor 15 and the operating personnel can effect the storage of the ink presetting characteristic curve adapted to the measured values of the current print job and improved, by entry through the use of a mouse, keyboard or touch screen. However, following the illumination of the signal for the learning, it is also possible for the ink presetting characteristic curve to be stored automatically by the control computer 15 and used as a new optimized ink presetting characteristic curve. In this case, the manual acknowledgement signal by the operating personnel is not required.

1. A method for determining optimized ink presetting characteristic curves for the control of inking units in printing presses by a computer, the method comprising the following steps:
acquiring measured values on a printing material produced by a printing press within the context of a running print job by a color measuring instrument;
comparing the acquired measured values with a color set point to be achieved;
determining fluctuations in the acquired measured values; and
if the fluctuations lie within a defined permissible tolerance band around the color set point, generating a signal in the computer to adapt and store the ink presetting characteristic curves being used.

2. The method according to claim 1, which further comprises choosing the tolerance band as a function of a continuous printing tolerance around the color set point.

3. The method according to claim 1, which further comprises analyzing data from a current print job and generating a signal to adapt and store the ink presetting characteristic curves used for the print job with the computer if the print job has no job data opposing learning.

4. The method according to claim 1, which further comprises generating a signal to adapt and store the ink presetting characteristic curves being used with the computer if the adapted ink presetting characteristic curves represent an improvement as compared with unadapted ink presetting characteristic curves for comparative jobs.

5. The method according to claim 1, which further comprises generating a signal to adapt and store the ink presetting characteristic curves being used for the print job with the computer if an operating state of the printing press is not being subjected to any setting operations or actions by operating personnel in the inking units.

6. The method according to claim 1, which further comprises generating a signal to adapt and store the ink presetting characteristic curves used for the print job with the computer if the operating state of the printing press is being subjected to any setting operations or actions by operating personnel in the inking units which can be corrected by computation.

7. The method according to claim 5, which further comprises generating a signal to adapt and store the ink presetting values used for the print job with the computer if the color set points are largely unchanged.

8. The method according to claim 1, which further comprises carrying out the step of acquiring the measured values on the printing material by a color measuring instrument located in the printing press and connected to the computer through a communications link.

9. The method according to claim 1, which further comprises carrying out the step of acquiring the measured values on the printing material by a color measuring instrument located outside the printing press and connected to the computer through a communications link.

10. The method according to claim 5, which further comprises generating a signal to adapt and store the ink presetting characteristic curves used for the print job with the computer if, after reaching a stable operating state and a color set point to be achieved, a minimum number of produced printing materials has been produced.

11. The method according to claim 1, which further comprises providing a display device connected to the computer, and passing on a signal from the computer to the display device to adapt and store the ink presetting characteristic curves used for the print job and generate a visual signal at the display device.

12. The method according to claim 1, wherein the signal to adapt and store the ink presetting characteristic curves used for a print job is an illumination of a lamp.

13. The method according to claim 1, which further comprises triggering, with the signal generated by the computer to adapt and store the ink presetting characteristic curves used for a print job, an automatic adaptation and storage of the current ink presetting characteristic curves as improved characteristic curves in the computer.

14. A printing press, comprising:
a display device; and
a computer for passing a signal to adapt and store ink presetting characteristic curves used for a print job on to said display device causing said display device to generate an optical signal, for carrying out the method according to claim 1.
